(19) United States
(12) Patent Application Publication
(10) Pub. No.: US 2002/0065852 A1
(43) Pub. Date: May 30, 2002

(54) Online guided resume creation system that allows dynamic style formatting

(76) Inventors: Matt Hendrickson, San Franciso, CA (US); Rob Jose, Pleasanton, CA (US); Ken Wlens, San Jose, CA (US)

Correspondence Address: SAWYER LAW GROUP LLP, P.O. Box 51418, Palo Alto, CA, 94303, US

(21) Appl. No.: 09/728,250

(22) Filed: Nov. 30, 2000

(51) Int. Cl. G06F 17/24

(52) U.S. Cl. 707/517; 707/530

(57) ABSTRACT

A method and system for allowing a user to dynamically change the style of an online resume that is created using an online guided resume creation system is disclosed. The method and system include displaying a plurality of resume styles from which a user may select, each resume style having a corresponding style sheet describing the style, The method and system further include prompting the user to enter data needed to create a resume, and to select a resume style from the plurality of styles. A file is automatically created from the user data. The file is then transformed into a resume file by applying the style sheet corresponding to the user's selection to the file, whereby the resume file is viewable online and printable.

### FIELD OF THE INVENTION

The present invention relates to using an online guided resume creation system to create resumes automatically on the Internet, and more particularly to dynamically changing the style of online resumes.

### BACKGROUND OF THE INVENTION

Presenting an effective resume is an essential key for conducting a successful career search. Generally, a prospective employer's first impression of a future employee is through the person's resume. Accordingly, much attention should be paid to how the resume looks, how it is organized, and whether the content is presented clearly and succinctly. After all, a qualified candidate who is able to convey to the reader that she is right for a job will most likely be successful in her job search.

PC software applications have been developed to assist individuals in preparing customized resumes. For example, the assignee of the present application has developed a PC software application that aids users in creating electronic resumes and automatically submitting the resumes to career websites on the Internet. Through a guided resume wizard, job seekers are prompted for all relevant information. Users can select from 100,000 pre-written resume phrases for every major career and then choose from 25 single-click resume designs that transform the entire resume into a different format. For a more detailed discussion, please refer to co-pending application No. 09/626,428, entitled METHOD AND SYSTEM FOR QUERYING AND POSTING TO MULTIPLE CAREER WEBSITES ON THE INTERNET FROM A SINGLE INTERFACE, filed Jul. 27,2000.

Although the PC software application described above functions well for its intended purpose, the user cannot view his or her resume on the Internet as a web page. Online applications for generating resumes have emerged where a user can create a resume online without accessing a PC software application. These tools generally prompt the user to enter generic resume information, such as educational background and past job experience. Some applications may allow the user to pick a resume style, such as a functional or chronological resume. This information is then merged into a predetermined template corresponding with the resume style chosen.

Although somewhat convenient, there are several draw backs associated with these conventional tools. First, the online applications only allow the user to enter text. Because the user information is merged into a predetermined template, the user does not have the flexibility to customize the style of the resume. For example, the user is limited to the section names provided by the template, and may not select different headings or categories. Further, the user cannot alter the order in which the sections appear. A second drawback is that the user is not allowed to customize the look and feel of the resume because the user cannot format the data entered, e.g., italicizing certain phrases or boldfacing headings. Therefore, the user does not have complete control as to how his or her resume appears online.

Third, in the conventional online application, the user information is merged directly into an HTML template corresponding to the style selected by the user to form the online resume. Therefore, if the user is not pleased with the resume style selected and selects another, the user information is discarded and the user must reenter the data for the newly chosen style. This can be a time consuming process if the user would like to see her resume in several different styles to choose the most appealing style.

Accordingly, what is needed is an improved method and system for allowing a user to dynamically change the style of an online resume, and for allowing a user to have some control over the content and look of the resume. The present invention addresses such needs.

### SUMMARY OF THE INVENTION

A method and system for allowing a user to dynamically change the style of an online resume that is created using an online guided resume creation system is disclosed. The method and system include displaying a plurality of resume styles from which a user may select, each resume style having a corresponding style sheet describing the style, The method and system further include prompting the user to enter data needed to create a resume, and to select a resume style from the plurality of styles. A file is automatically created from the user data. The file is then transformed into a resume file by applying the style sheet corresponding to the user's selection to the file, whereby the resume file is viewable online and printable.

According to the system and method disclosed herein, the guided resume creation system in accordance with the present invention enables a user to create a customized online resume, wherein the user is allowed to dynamically change the style of a resume on-the-fly.

### BRIEF DESCRIPTION OF THE DRAWINGS

FIG. 1 is a block diagram illustrating a system for dynamically changing the style of a resume on the Internet in accordance with a preferred embodiment of the present invention.

FIG. 2 is a flow chart illustrating a process for allowing users to dynamically change the style format of a resume on the Internet in accordance with a preferred embodiment of the present invention.

FIG. 3 is a block diagram illustrating an example card displayed to the user during data entry in the Resume Write section of the resume application.

FIG. 4 is a block diagram illustrating a sample resume in style Stanford.

FIG. 5 is a flow chart illustrating the process for automatically providing delimiters in an online resume in accordance with a preferred embodiment of the present invention.

FIGS. 6A-6D are a series of block diagrams illustrating an example for automatically providing delimiters in an online resume in accordance with a preferred embodiment of the present invention.

FIG. 6A is a block diagram illustrating a first example card for the Experience section of a resume displayed to the user during data entry for the example.

FIG. 6A′ is a block diagram illustrating a second example card for the Experience section of a resume displayed to the user during data entry for the example.

FIG. 6B is a hypothetical case statement for the Experience section for a selected resume style used for the example.

FIG. 6C is the case statement output in HTML corresponding to the particular case statement executed.

FIG. 6D is the case statement output in HTML corresponding to a different sum of fields.

### DETAILED DESCRIPTION

The present invention relates to creating a user customized resume web page using an online guided resume creation system, wherein the user can dynamically change the resume style. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

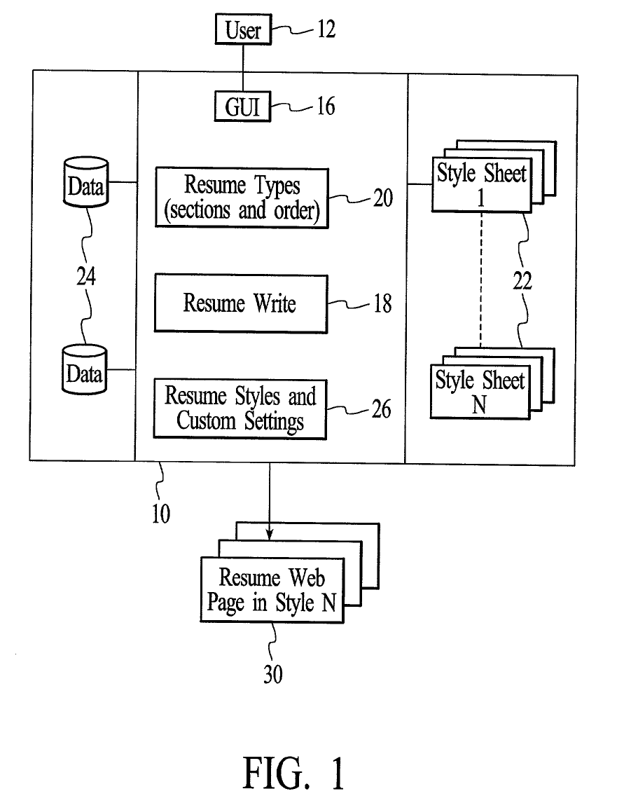

FIG. 1 is a block diagram illustrating a system for allowing a user to create a resume having a custom format style on the Internet in accordance with a preferred embodiment of the present invention. The system includes a web-based application 10 that aids users 12 in creating customized resume web pages 30, preferably formatted in HTML, on the Internet through a graphical user interface 16. Although the present invention will be described referring primarily to resumes formatted in HTML, those of ordinary skill in the art will appreciate that the resume can be formatted in other document formats, including but not limited to, .TXT, .RTF, and .PDF files.

Referring again to FIG. 1, the resume application 10 includes several features for helping the user 12 to create an effective resume, including a resume write feature 18, a resume type feature 20, and a resume styles and custom settings feature 26. The resume write feature 18 guides the user 12 through a step-by-step process for writing the resume. The resume type feature 20 allows the user 12 to select from a variety of resume types, which generally defines the sections and their order in the resume. The resume styles and custom settings feature 26 allows the user 12 to select and customize the style of his or her resume. The resume application 10 also includes at least one database 24 for storing information entered by the user 12, and a library of style sheets 22 corresponding to a variety of resume styles from which the user 12 may choose.

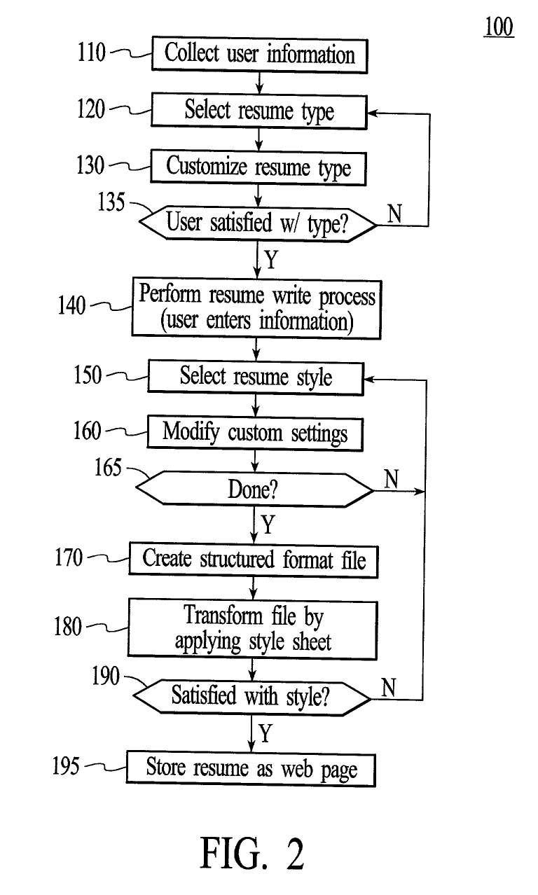

FIG. 2 is a flow chart illustrating a process 100 for creating a resume online where the user 12 can dynamically change the style of the resume in accordance with a preferred embodiment of the present invention. Referring to FIG. 2, the process 100 begins by collecting user information from the user 12 in step 110. User information includes personal information, such as the user's name, address, and contact information. The user 12 is then prompted to select a resume type from a list of types in step 120. Resume types describe the organizational format of a resume, and include, for example, chronological and functional resumes. For each resume type, the user 12 is presented with suggested sections for resume text and the order of those sections. In step 130, the user 12 may customize the resume type by deleting or adding sections as well as by defining the order in which the sections appear on the resume.

Once the user 12 has finished selecting the resume type and optionally customizing the resume type in step 135, the user 12 is prompted to enter relevant information relating to each section in step 140. This step is referred to as the resume write process 18, and will be described in more detail below. Information is collected by displaying cards to the user 12 which contain a number of fields in which the user 12 enters corresponding data.

Once the user 12 has completed the resume write process 140, the user 12 is prompted to select a resume style from a list of styles in step 150. Generally, the resume style defines the appearance of a resume, e.g., by setting margins, font type, font size, and text justification. A single-click resume style feature allows the user 12 to choose a resume style from pre-formatted templates. The user 12 is shown a description and graphical preview of each of the formatting styles.

According to the present invention, the user 12 has the ability to choose a particular style and then make modifications to that style through a custom settings feature (step 160). The custom settings feature in step 160 allows the user 12 to change formatting parameters in the style. In one embodiment, the resume 30 is broken down to its fundamental elements, e.g., name, address, section titles, etc. The user 12 then is allowed to modify the appearance of those elements by, for example, changing the font size, or the font. Thus, for example, if the user 12 selects a style which boldfaces the user's name, the user 12 can modify that style by going into the custom settings feature and changing the setting to make the name appear in italics. In addition, the custom settings feature allows the user 12 to manipulate the line spacing of the resume 30. For example, the user 12 can change the line spacing between sections and text. With this feature, the user 12 can control the page length of the resume 30 without necessarily altering the resume's 30 content. Accordingly, the user 12 has the ability to customize a selected resume style to suit the user's 12 tastes. This process may be repeated as necessary in step 165.

Next, in step 170, all of the information entered by the user 12, e.g., resume type and style, modifications thereto and data, is stored in a database 24 and used to create a structured format file, preferably using Extensible Markup Language (XML). XML is used for defining data elements on a web page. It uses a similar tag structure as HTML, but allows the tags to be defined by the developer of the page. Whereas HTML generally defines how elements are displayed, XML defines what those elements contain. Although the present invention is described utilizing XML, those skilled in the art will appreciate that other markup languages could be utilized and such utilization would fall within the scope of this invention.

Finally, in accordance with this preferred embodiment, the XML file is transformed into an HTML formatted file 30 via an Extensible Stylesheet Language (XSL) style sheet 22 in step 180. XSL is used for creating style sheets for XML documents. A style sheet 22 is a file that is used to store margins, tabs, fonts and other layout settings for a particular category of document. When a style sheet 22 is selected, its format settings are applied to the documents created under it. Thus, for each resume style available to the user 12, a corresponding XSL style sheet 22 exists. Along with defining margins, fonts and other layout settings, the XSL style sheet 22 also defines where the resume content is placed in the document, and where punctuation, separators, and other delimiters are placed. Therefore, the user 12 need not worry about placing delimiters in the resume because they are provided automatically by the guided system of the present invention.

At this stage, the user 12 may view the resume 30 on the user's browser, and determine whether he or she is satisfied with the style in step 190. If the user 12 is not pleased with the resume style, the user 12 may select a different style and/or customize the style in steps 150 and 160, respectively, and the resume with the new style may be displayed to the user 12 after steps 170 and 180 have been executed. This process can be repeated until the user 12 is satisfied. Therefore, unlike the conventional online applications, the user 12 can perform dynamic on-the-fly transformations between styles. In addition, the user 12 has the ability to customize a resume style by utilizing the custom settings feature. It should be noted that each time the user 12 selects a different style or changes a custom setting, such selections are reflected in the XML structured file.

When the user 12 is satisfied with the content and appearance of the resume 30, the resume file is stored as a web page 30 on the internet in step 195. As such, the user 12 can easily submit the resume 30 to a prospective employer over the Internet by sending the web address to the employer. Moreover, anywhere the user 12 has access to the Internet, the user 12 also has easy access to his or her resume 30, which can be downloaded and/or printed. Moreover, because the user 12 information is stored in the database 24 in the system, the user 12 can edit the content of the resume web page 30 at any time by returning to the online application 10 and accessing the database 24.

The operation of the resume write process 18, and the automatic delimiter feature will now be described in more detail.

The resume write process 18 is a step-by-step guided resume creation system that helps job seekers create professional resumes 30. Through a guided resume wizard, job seekers are prompted for all relevant information with a card-like interface with next/back buttons that collects relevant information from the user 12 for each section of a resume 30.

According to the present invention, the guided resume wizard includes several data entry features and several data formatting features that facilitate the generation of a resume. The data entry features include a title selector feature and a pre-written phrases/words feature. The title selector feature is a drop-down list displayed at each stage during the step-by-step wizard for the user 12 to enter or change the name of a particular resume section, or Section Title, on the resume. For instance, for OBJECTIVE, the user 12 can easily choose, OPENING STATEMENT, SUMMARY etc. directly from a drop down list, or type in a custom heading, if so desired. This will rename the section of the resume to fit the user's 12 preference. For EMPLOYMENT, users 12 can easily change to EMPLOYMENT SUMMARY or EXPERIENCE.

The pre-written phrases/words is a data entry feature that includes a set of buttons displayed at each stage of the step-by-step wizard that assist the user 12 in writing the resume. An action phrases button provides a list of pre-written phrases for the major sections of a resume, including OBJECTIVE, SKILLS/ABILITIES, EXPERIENCE, and EDUCATION. An action words button provides a listing of 3,600 action words which are used to empower the user resume. Job Descriptions is a listing of several hundred pre-written job descriptions for every major career.

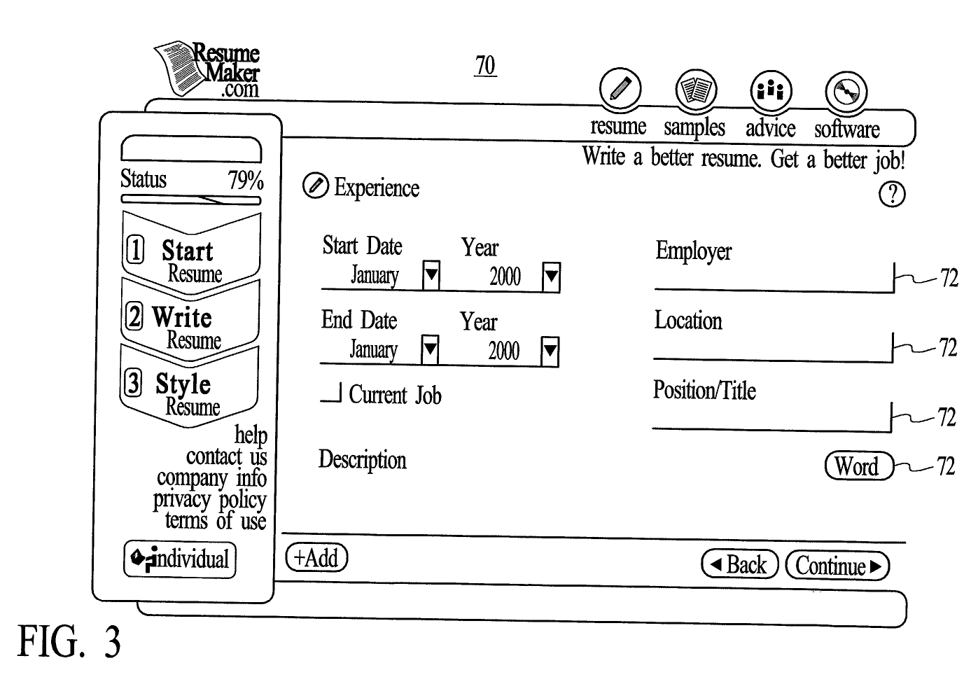

FIG. 3 is a block diagram illustrating an example card 70 displayed to the user 12 during data entry in the resume write process 140. The card 70 includes a series of subject fields 72 for the user 12 to enter the requested information. After the card 70 is filled in by the user 12, the data in the subject fields 72 is stored in the database 24. The subject fields 72 are utilized later in the process to determine the placement of delimiters in the resume 30.

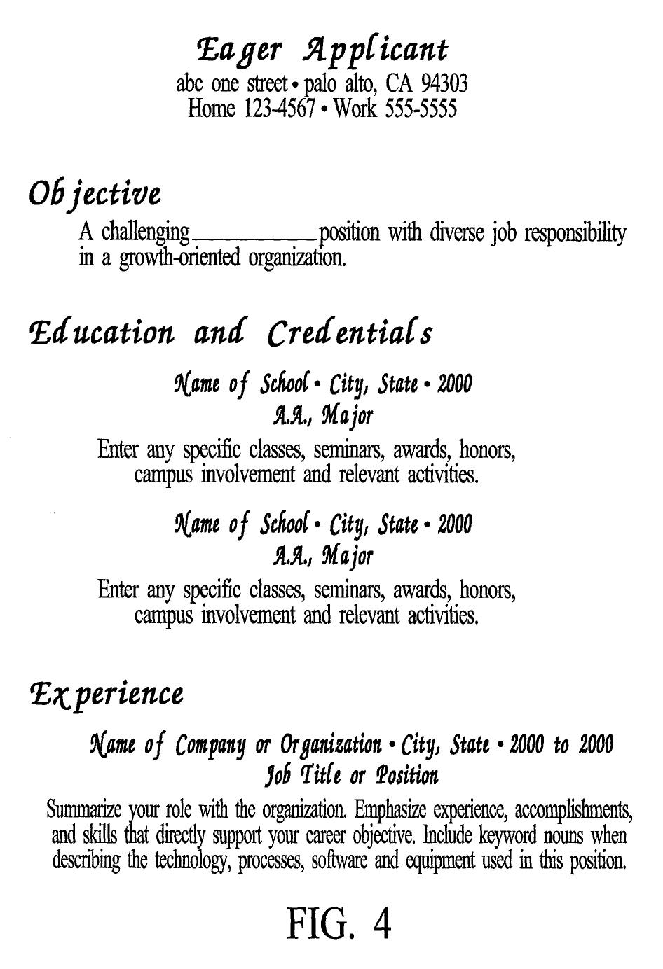

Commonly, a single block of text in a resume 30 may comprise multiple subject fields 72 from the database 24, and in most instances are separated by delimiters such as commas, semicolons, and so on. Referring to FIG. 4, which is a block diagram illustrating a sample resume in style Stanford, the user's home telephone number field is separated from the work telephone number field by a small dot. The user 12 does not enter delimiters (the dot) when entering data into the fields 72. The present invention stores the layouts of resumes in the XSL style sheets 22, including the position of each field 72 in each section within the resume and the delimiters separating those fields 72.

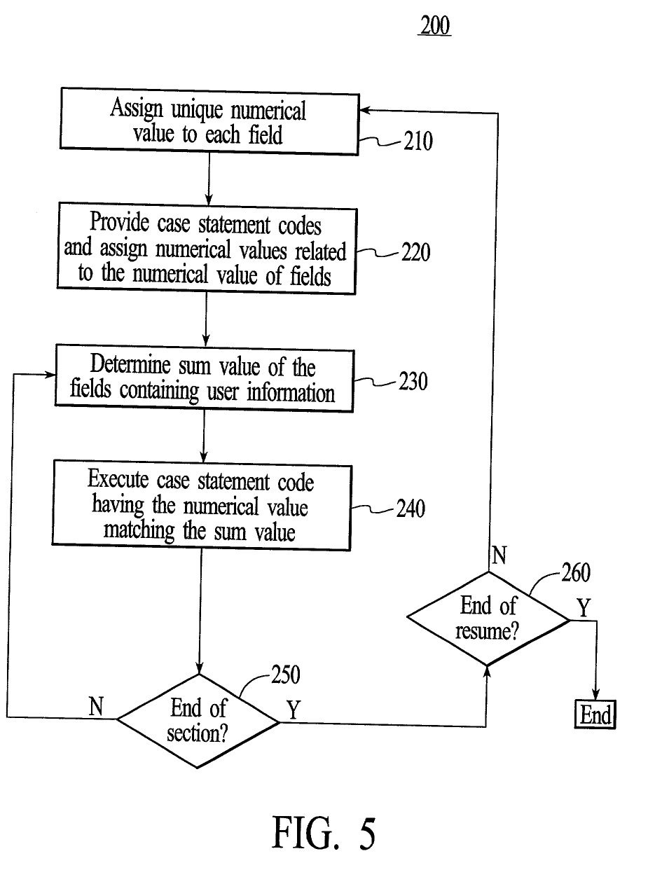

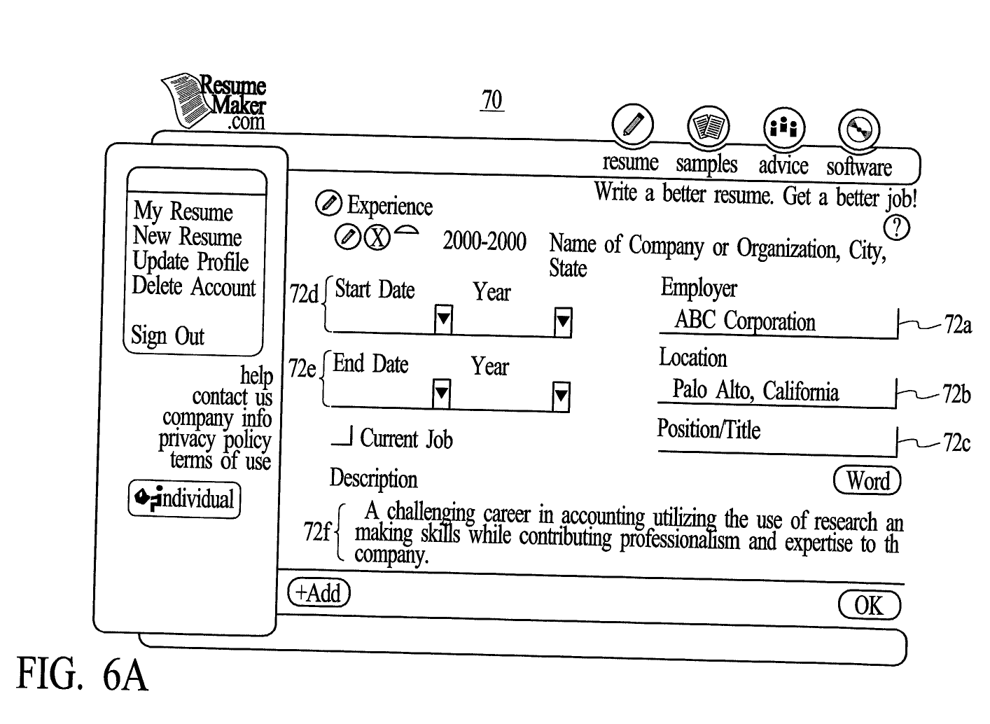

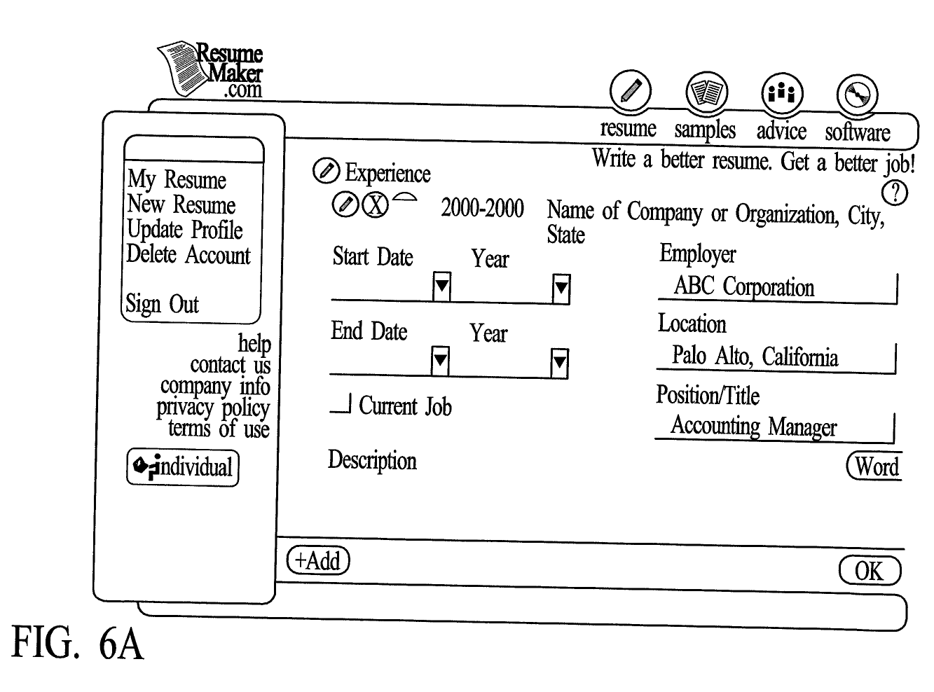

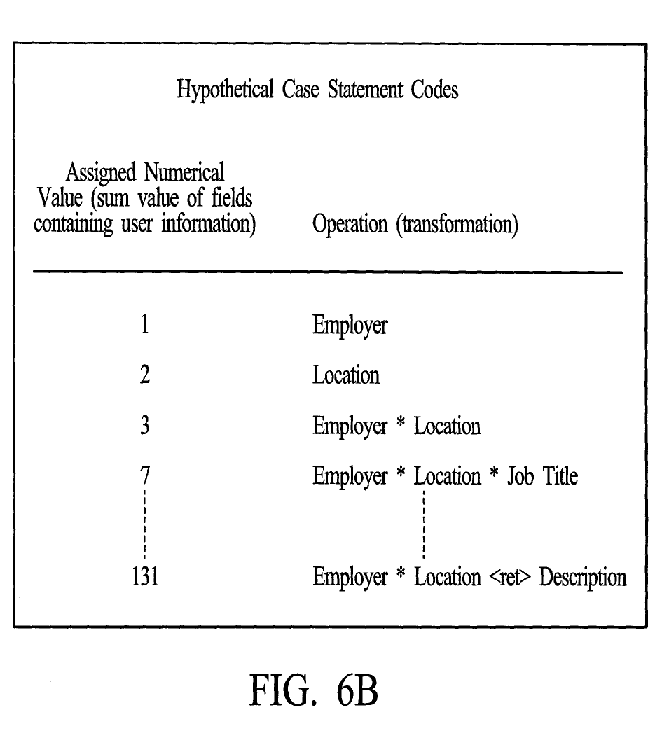

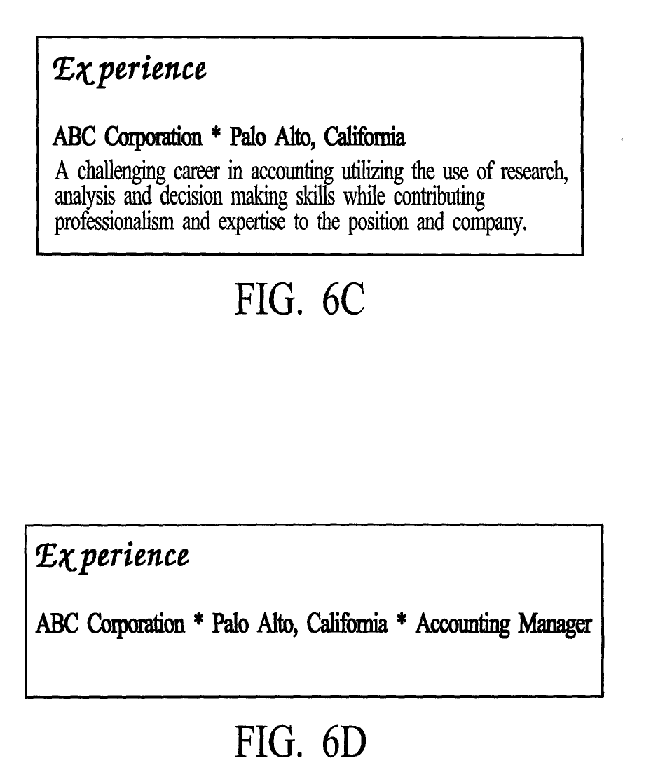

FIG. 5 is a flow chart illustrating the process 200 by which the delimiters are automatically provided. The XSL style sheet 22 transforms the XML file section by section. As stated above, the user information entered during the resume write process 140 is entered and stored in subject fields 72 in the database 24. In step 210, each field 72 in a section is assigned a unique numerical value, wherein the number doubles for each successive field. For example, FIG. 6A is a diagram depicting a card 70 corresponding to the Experience section in a resume 30. The user 12 is prompted to enter data into the fields Employer 72a, Location 72b, Position/Title 72c, Start Date and Year 72d, End Date and Year 72e, and Description 72f. Each field 72 is assigned a unique numerical value. Therefore, for purposes of this example, the Employer field is 1, Location is 2, Position/Title is 4, Start Date is 8, State Year is 16, End Date is 32, End Year is 64, and Description is 128.

Referring again to FIG. 5, each XSL style sheet 22 is provided with a plurality of instruction blocks comprising of a series of case statement codes corresponding to each section of the resume, where, in step 220, each case statement code is assigned a numerical value related to the two-fold increasing numerical values assigned to the fields 72. The instruction block determines which fields 72 and delimiters will appear and where within that section. The value assigned to each case statement code corresponds to a respective sum of the values of the fields 72 which contain information entered by the user 12. So, for example, FIG. 6B illustrates, in conceptual form only, a hypothetical set of case statement codes corresponding to the experience section card 70 in FIG. 6A.

In operation, the user 12 is prompted to fill in the fields 72, and the values of the fields 72 in that section containing user data are added together to determine the sum value in step 230. Referring again to FIG. 6A, the user 12 has entered data into the Employer, Location, and Description fields only. The sum of the values of the combination of fields containing user data is 131 (1+2+128). Depending on the sum, which is a unique numerical value because the assigned field values increase twofold, the field output and delimiters will change.

Once the sum is determined, the case statement code having the numerical value matching the sum value is executed, thereby providing the content and delimiters automatically in step 240. Thus, referring again to the example in FIGS. 6A and 6B, according to the hypothetical case statement code corresponding to the sum of 131, the XSL style sheet 22 will output in HTML the name of the company and its location on one line separated by a small asterix, followed by the job description on the next line (see FIG. 6C). In another illustration, suppose the user 12 has entered data into the Employer, Location, and Position/Job Title fields 72 only, as shown in FIG. 6A′. The sum is now 7, and the corresponding case statement code (FIG. 6B) will output the name of the company, its location, and the job title on one line separated by small asterix, as shown in FIG. 6D. Hence, the placement of delimiters is not a rigid function, but rather a flexible feature which takes into consideration the user's data entry.

For some resume sections, for example the Experience section, the section may contain several information blocks. For example, a user 12 may fill in several experience section cards 70 to reflect different employers. Therefore, referring again to FIG. 5, the processes embodied in steps 230 and 240 are repeated for each card 70 until the section is completely transformed in step 250. When the section transformation is complete, the process continues to, and repeats for, the next section until the resume is completely transformed in step 260.

A method and system for creating an online resume where the resume style can be dynamically changed using a guided resume creation system has been disclosed. Although the present invention has been described in accordance with the embodiments shown, one of ordinary skill in the art will readily recognize that there could be variations to the embodiments and those variations would be within the spirit and scope of the present invention. For instance, the final resume file can be formatted in other formats, including but not limited to, .TXT, .RTF and .PDF, and is not limited to HTML. Accordingly, many modifications may be made by one or ordinary skill in the art without departing from the spirit and scope of the appended claims.

What is claimed is:

1. A method for allowing a user to dynamically change the style of an online resume that is created using an online guided resume creation system, the system comprising at least one database, the at least one database comprising a plurality of fields requiring input of data, the method comprising the steps of:
a) displaying a plurality of resume styles for user selection, each one of the plurality of resume styles having a corresponding style sheet describing the resume style, including positions within the resume style of fields of data from the database;
b) collecting data from a user;
c) prompting the user to select one resume style from the plurality of resume styles;
d) automatically creating a file from the user data;
e) applying the style sheet corresponding to the selected resume style to the file to transform the file into a resume file that is viewable online and printable.

2. The method of claim 1 further comprising the step of:
f) repeating steps (c)-(e) until the user is satisfied with the resume file, thereby allowing the user to dynamically apply different styles to the resume file.

3. The method of claim 2 further comprising the steps of:
mapping the user information to the plurality of fields in the database; and
storing the mapped user information in the database.

4. The method of claim 3 further comprising the step of allowing the user to edit the resume file.

5. The method of claim 4 further comprising the step of providing the user with an option to view the resume file.

6. The method of claim 4 further including the step of displaying the resume file.

7. The method of claim 3 further including the step of storing the resume file as a web page on the Internet.

8. The method of claim 1, wherein the resume file is formatted in HTML.

9. The method of claim 8, wherein step (d) further comprises the step of utilizing XML to create the file.

10. The method of claim 9, wherein step (a) further comprises the step of providing the plurality of resume style sheets in XSL.

11. The method of claim 1, wherein step (b) further includes the step of allowing the user to select a resume type from a plurality of resume types, the resume type describing a plurality of sections in the resume and an order in which the plurality of sections will appear on the resume.

12. A computer-readable medium for allowing a user to dynamically change the style of an online resume that is created using an online guided resume creation system, the system comprising at least one database, the at least one database comprising a plurality of fields requiring input of data, the computer-readable medium comprising the instructions of:
a) displaying a plurality of resume styles for user selection, each one of the plurality of resume styles having a corresponding style sheet describing the resume style, including positions within the resume style of fields of data from the database;
b) collecting data from a user;
c) prompting the user to select one resume style from the plurality of resume styles;
d) automatically creating a file from the user data;
e) applying the style sheet corresponding to the selected resume style to the file to transform the file into a resume file in the selected resume style, whereby the resume file is viewable online and printable.

13. The computer-readable medium of claim 12 further comprising the instruction of:
f) repeating steps (c)-(e) until the user is satisfied with the resume file.

14. The computer-readable medium of claim 13 further comprising the instructions of:
mapping the user information to the plurality of fields in the database; and
storing the mapped user information in the database.

15. The computer-readable medium of claim 14 further comprising the instruction of allowing the user to edit the resume file.

16. The computer-readable medium of claim 15 further comprising the instruction of providing the user with an option to view the resume file.

17. The computer-readable medium of claim 15 further comprising the instruction of displaying the resume file.

18. The computer-readable medium of claim 14 further comprising the instruction of storing the resume file as a web page on the Internet.

19. The computer-readable medium of claim 12, wherein the resume file is formatted in HTML.

20. The computer-readable medium of claim 19, where in instruction (d) further comprises an instruction for utilizing XML to create the file.

21. The computer-readable medium of claim 20, wherein instruction (a) further includes an instruction for providing the plurality of resume style sheets in XSL.

22. The computer-readable medium of claim 12, wherein instruction (b) further includes the instruction of allowing the user to select a resume type from a plurality of resume types, the resume type describing a plurality of sections in the resume and an order in which the plurality of sections will appear on the resume.

23. A system for allowing a user to dynamically change the style of an online resume that is created using an online guided resume creation system, the system comprising at least one database, the at least one database comprising a plurality of fields requiring input of data, comprising:
a plurality of style sheets for describing different resume styles, including positions within the resume styles of fields of data from the database;
a user interface for collecting information from a user and for allowing the user to select a resume style from a plurality of resume styles;
means for automatically creating a file from the user data;
means for transforming the file into a resume file by applying the style sheet corresponding to the user selected resume style to the file.

24. The system of claim 23, wherein the user interface allows the user to reselect resume styles to apply to the resume file.

25. The system of claim 24 wherein the user information is mapped to the plurality of fields in the database, and the mapped user information is stored in the database.

26. The system of claim 25 further comprising means for allowing the user to edit the resume file.

27. The system of claim 26 further including means for providing the user with an option to view the resume file.

28. The system of claim 26 wherein the resume file is displayed to the user.

29. The system of claim 25 wherein the resume file is stored as a web page on the Internet.

30. The system of claim 23, wherein the file is created using XML.

31. The system of claim 30, wherein the plurality of resume style sheets are in XSL.

32. The system of claim 31, wherein the resume file is formatted in HTML.

33. The system of claim 23, wherein the means for collecting data further includes means for allowing the user to select a resume type from a plurality of resume types, the resume type describing a plurality of sections in the resume and an order in which the plurality of sections will appear on the resume.

34. A method for automatically providing delimiters in an online resume that is created using an online guided resume creation system, the system comprising at least one database, the at least one database including a plurality of fields requiring input of data, the method comprising the steps of:
assigning a numerical value to each field of the plurality of fields in the database;
providing a plurality of style sheets, each style sheet of the plurality of style sheets describing a different resume style;
providing a plurality of case statement codes in each style sheet, wherein each case statement code represents a respective sum value of numerical values of a combination of fields associated with a section;
prompting the user to enter data into the plurality of fields;
determining the sum of the combination of fields associated with the section by adding the numerical values assigned to the fields containing user data; and
executing the case statement code corresponding to the sum value of the combination of fields to determine where the fields are positioned and where the delimiters are placed relative to the fields.

35. The method of claim 34, wherein the numerical value assigned to each field increases by twofold for each successive field.

36. The method of claim 35 further including the step of using XML to create a file from the user data and applying a style sheet from the plurality of style sheets to transform the file into an HTML resume file.

37. The method of claim 36 further including the step of storing the HTML resume as a web page on the Internet.

38. A method for allowing a user to customize a style of an online resume that is created using an online guided resume creation system, the system comprising at least one database, the at least one database comprising a plurality of fields requiring input of data, the method comprising the steps of:
a) displaying a plurality of resume styles for user selection, each one of the plurality of resume styles having a corresponding style sheet describing the resume style, including positions within the resume style of fields of data from the database;
b) collecting data from a user;
c) prompting the user to select one resume style from the plurality of resume styles, the resume style having a plurality of custom settings;
d) allowing the user to adjust the plurality of custom settings associated with the selected resume style;
e) automatically creating a file from the user data, the user selected resume style, and the adjusted plurality of custom settings;
f) applying the style sheet corresponding to the selected resume style to the file, thereby transforming the file into a resume file that is viewable online and printable.

39. The method of claim 38, wherein the allowing step (d) further comprises the steps of:
d1) dividing the online resume into a plurality of common elements, the plurality of common elements being components of a typical resume; and
d2) allowing the user to modify the appearance of a common element of the plurality of common elements.

40. The method of claim 39, wherein the allowing step (d) further comprises the step of:
d3) allowing the user to adjust a line spacing component of the online resume, whereby the user can modify a distance between lines of the online resume.

41. The method of claim 40 further comprising the step of:
g) repeating steps (c)-(f) until the user is satisfied with the resume file.

42. The method of claim 41 further comprising the steps of:
mapping the user information to the plurality of fields; and
storing the mapped user information in the at least one database.

43. The method of claim 42 further comprising the step of storing the resume file as a web page on the Internet.
